(19) United States
(12) Patent Application Publication
(10) Pub. No.: US 2008/0000496 A1
(43) Pub. Date: Jan. 3, 2008

(54) Method of recycling crystal sensor of evaporation apparatus

(75) Inventors: Ock Hee Kim, Gyeonggi-do (KR); Ae Kyung Jeon, Seoul (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/819,732

(22) Filed: Jun. 28, 2007

(30) Foreign Application Priority Data
Jun. 30, 2006 (KR) 10-2006-0060611

(51) Int. Cl. B08B 3/12

(52) U.S. Cl. 134/1; 134/28; 134/29

(57) ABSTRACT

A method of cleaning a crystal sensor of an evaporation apparatus is disclosed, wherein the crystal sensor of monitoring an evaporation level is cleaned for the reuse of device, the method comprising collecting the crystal sensor after performing a monitoring step for a material evaporated and deposited on a substrate for a preset period of time, cleaning the crystal sensor by dipping the crystal sensor into a wet etchant, and drying the cleaned crystal sensor.

This application claims the benefit of Korean Patent Application No. 2006-60611 filed on Jun. 30, 2006, which is hereby incorporated by reference as if fully set forth herein.

### BACKGROUND OF THE INVENTION

1. Field of the Invention

The present invention relates to a flat panel display device, and more particularly, to a method of cleaning a crystal sensor of an evaporation apparatus, wherein the crystal sensor of monitoring an evaporation level is cleaned for the reuse of device.

2. Discussion of the Related Art

One of various flat panel displays, an organic light-emitting diode (OLED) display, emits light by itself. In comparison to a liquid crystal display (LCD) device, the OLED display has the advantageous properties of wide viewing angle and high contrast ratio. It is unnecessary for the OLED display to provide a backlight unit, so that the OLED display realizes thin profile, light in weight and low power consumption.

Furthermore, the OLED display is driven by a low voltage, and the OLED display has a rapid response speed. Also, the OLED display is fabricated with a solid matter, whereby the OLED display can endure the external impact and can be used in the wide scope of temperature. Especially, the OLED display may be fabricated only by deposition and encapsulation apparatuses, so that a method of fabricating the OLED display is simplified.

If the OLED display is driven in an active matrix type where each pixel includes a thin film transistor of switching element, the same luminance can be realized even in case of applying a low current, thereby realizing the low power consumption, fineness, and large size of the device.

The OLED display represents images by exciting a fluorescent material using a carrier including an electron and a hole.

In the meantime, the OLED display is generally driven in a passive matrix type having no additional thin film transistor. However, the passive matrix type has limitations on the lower consumption and lifespan of device. Thus, there are researches and studies for an active matrix type OLED display which is suitable for a next-generation display requiring high resolution and large size.

The OLED display is divided into a lower light-emitting mode and an upper light-emitting mode based on whether an organic light-emitting layer is positioned on a lower substrate or an upper substrate. For example, if realizing the active matrix type in the upper light-emitting mode, a thin film transistor array is provided on the lower substrate. If the light-emitting layer is positioned on the upper substrate, it is referred to as a dual plate type OLED (DOD) display.

Hereinafter, a related art OLED display will be described with reference to the accompanying drawings.

FIG. 1 is a cross section view of illustrating a related art OLED display. Referring to FIG. 1, the related art OLED display is comprised of a first substrate 10; a second substrate 20; a thin film transistor array including a thin film transistor (TFT) in each sub pixel of the first substrate 10; an organic light-emitting diode (E) formed on the second substrate 20; and a seal pattern 30 formed in the circumference of first and second substrates 10 and 20. To supply a current to the organic light-emitting diode (E), there are a transparent electrode 16 and a connector 17 which connects the thin film transistor (TFT) to a second electrode 25 by each sub pixel.

At this time, the organic light-emitting diode (E) is comprised of a first electrode 21 which functions as a common electrode; a second electrode separator 26 which is positioned in the boundaries of every sub pixel above the first electrode 21; organic light-emitting layers 22, 23 and 24; and the second electrode 25. In order to form the organic light-emitting diode (E), the first electrode 21, the second electrode separator 26, the organic light-emitting layers 22, 23 and 24 and the second electrode 25 are deposited in sequence; and then the organic light-emitting layers 22, 23 and 24 and the second electrode 25 are separated by the second electrode separator provided on the boundaries of every sub pixel.

At this time, the organic light-emitting layer is comprised of a first carrier-transmitting layer 22; a light-emitting layer 23; and a second carrier-transmitting layer 24, which are deposited in sequence. The first and second carrier-transmitting layers 22 and 24 inject and transport an electron or hole to the light-emitting layer 23.

The first and second carrier-transmitting layers 22 and 24 are determined based on the position of anode and cathode. For example, supposing that the light-emitting layer 23 is selected from a high molecular substance; the first electrode 22 serves as the anode; and the second electrode 24 serves as the cathode. In this case, the first carrier-transmitting layer 22 which is positioned adjacent to the first electrode 21 is comprised of a hole injection layer and a hole transporting layer deposited in sequence; and the second carrier-transmitting layer 24 which is positioned adjacent to the second electrode 25 is comprised of an electron injection layer and an electron transporting layer deposited in sequence.

Also, the first and second carrier-transmitting layers 22 and 24 and the light-emitting layer 23 may be formed of the high molecular substance or low molecular substance. If using the low molecular substance, they are formed in a vacuum deposition method. Meanwhile, if using the high molecular substance, they are formed in an ink jet method.

Unlike a general spacer for the LCD device, a conductive spacer 17 functions as an electric connector between the two substrates as well as cell-gap maintenance. The conductive spacer 17 has a predetermined height between the two substrates.

The thin film transistor (TFT) corresponds to a driving thin film transistor connected to the organic light-emitting diode (E). The thin film transistor (TFT) includes a gate electrode 11 which is formed on a predetermined portion of the first substrate 10; a semiconductor layer 13 which is formed in shape of an island to cover the gate electrode 11, and source and drain electrodes 14a and 14b which are formed at both sides of the semiconductor layer 13. In addition, a gate insulation layer 12 is formed on an entire surface of the first substrate 10, wherein the gate insulation layer 12 is interposed between the gate electrode 11 and the semiconductor layer 13. Then, a passivation layer is formed on the gate insulation layer 12 including the source and drain electrodes 14a and 14b. At this time, the drain electrode 14b is electrically connected to the transparent electrode 16 formed on the passivation layer 15 through a contact hole formed in the passivation layer 15. The upper side of transparent electrode 16 is brought into contact with the conductive spacer 17.

The conductive spacer 17 electrically connects the drain electrode 14b of thin film transistor (TFT) provided by each sub pixel to the second electrode 25 formed on the second substrate 20. The conductive spacer 17 is formed by coating a column-shaped spacer of organic insulation material with a metal material. The sub pixels of first substrate 10 are electrically connected to the sub pixels of second substrate 20 by a one-to-one correspondence.

The metal material for the conductive spacer 17 is selected from a conductive material, preferably, a metal material having the softness and low resistance value. At this time, the first electrode 21 is formed of a transparent electrode material, and the second electrode 25 is formed of a light-shielding metal layer. Also, the interval between the first and second substrates 10 and 20 may be filled with an inert gas or an insulating liquid.

Although not shown, the first substrate 10 includes a scanning line; a signal line crossing the scanning line at a predetermined interval with each other; a power supplying line; and a storage capacitor.

For a dual plate type OLED display, there is a bus line formed in shape of a grid on the first electrode 21 of transparent electrode material having high resistivity. The bus line prevents a voltage value from being lowered on the first electrode 21.

In the meantime, the organic light-emitting layer is formed on the second substrate 20. The organic light-emitting layer is formed of an organic light-emitting material which emits a predetermined light for each sub pixel.

FIG. 2 is a cross section view of illustrating an apparatus of forming an organic light-emitting layer of an OLED display according to the related art.

To evaporate thin films of red, green and blue organic light-emitting layers and a cathode layer by the shadow mask 100, a mask-frame assembly 250 is positioned at an opposite side of an organic-layer evaporation crucible 202 provided inside a vacuum chamber 201, and a substrate 300 is mounted on the mask-frame assembly 250. Thereon, there is a magnet unit 400 which is operated to closely adhere the shadow mask 100 supported by the mask-frame assembly 250 to the substrate 300, whereby the shadow mask 100 is closely adhered to the substrate 300.

As operating the organic-layer evaporation crucible 202, the organic material or cathode material provided in the organic-layer evaporation crucible 202 is evaporated and is adhered to the substrate 30.

Although not shown, there is a crystal sensor for monitoring, provided at the other side of the organic-layer evaporation crucible 202 and the shadow mask 100. Based on the operation of the organic-layer evaporation crucible 202, the evaporated material is supplied to the crystal sensor as well as the substrate 300. Thus, the crystal sensor is vibrated by the evaporated material, so that the crystal sensor determines the evaporation level of material on the substrate 300.

If operating the crystal sensor for a preset period of time, the material evaporated on the surface of the crystal sensor is increased in thickness. Thus, the sensitivity of the crystal sensor is deteriorated so that it is impossible to monitor the precise evaporation level. In this respect, it is necessary to replace the crystal sensor periodically.

If not replacing the crystal sensor, the sensing process is not performed due to the malfunction of the crystal sensor. However, since the crystal sensor is expensive, the fabrication cost of the OLED device using the crystal sensor increases inevitably.

Accordingly, the related art crystal sensor used for the evaporation apparatus of the OLED device has the following disadvantages.

As the crystal sensor is operated for the monitoring of the evaporation level, the evaporated material is adhered to the surface of the crystal sensor. After the preset period of time, it is necessary to replace the crystal sensor. If not replacing the crystal sensor, the sensitivity of crystal sensor becomes low, whereby the sensing process is not performed due to the malfunction of the crystal sensor. Since the crystal sensor is expensive, the fabrication cost of the OLED device using the crystal sensor increases inevitably. In this case, if the vibration period of the crystal sensor is below a preset value, the crystal sensor is replaced.

To increase the lifespan of the crystal sensor, the ten crystal sensors are together loaded on the chamber and are rotated in a revolver type, or one crystal sensor is turned-on/off selectively to perform the monitoring process of the evaporation level (thickness) only in the predetermined time by a shutter. However, the former uses the plurality of crystal sensors, and the latter necessarily requires the additional shutter.

### SUMMARY OF THE INVENTION

Accordingly, the present invention is directed to a method of cleaning a crystal sensor of an evaporation apparatus that substantially obviates one or more problems due to limitations and disadvantages of the related art.

An object of the present invention is to provide a method of cleaning a crystal sensor of an evaporation apparatus, wherein the crystal sensor of monitoring an evaporation level is cleaned for the reuse of device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of recycling a crystal sensor of an evaporation device comprises collecting the crystal sensor after performing a monitoring step for a material evaporated and deposited on a substrate for a preset period of time, cleaning the crystal sensor by dipping the crystal sensor into a wet etchant, and drying the cleaned crystal sensor.

At this time, cleaning the crystal sensor is performed by applying ultrasonic waves.

Also, drying the cleaned crystal sensor is performed at a temperature of 80° C. to 500° C.

If the material evaporated and deposited on the substrate is an organic material, cleaning the crystal sensor uses an organic solvent. For example, the organic solvent is formed of at least one of acetone, IPA (alcohol-based (OH-based) material including Isopropyl Alcohol), MC (Methylene Chloride), THF (Tetrahydrofuran) and dichloride propane.

If the material evaporated and deposited on the substrate is an inorganic material, cleaning the crystal sensor uses an inorganic solvent. For example, the inorganic solvent is formed of acid-mixed solvent or alkali-mixed solvent.

The crystal sensor is periodically cleaned and dried.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross section view of illustrating an OLED device according to the related art;

FIG. 2 is a cross section view of illustrating an evaporation apparatus used to form an organic light-emitting layer of an OLED device according to the related art;

FIG. 3 is a schematic view of illustrating a sensing unit of an evaporation apparatus according to the present invention;

FIGS. 4A and 4B are cross section views of illustrating the initial state of the evaporation process of crystal sensor and the state after the curing process; and

FIG. 5 illustrates a cleaning method of a crystal sensor according to the present invention.

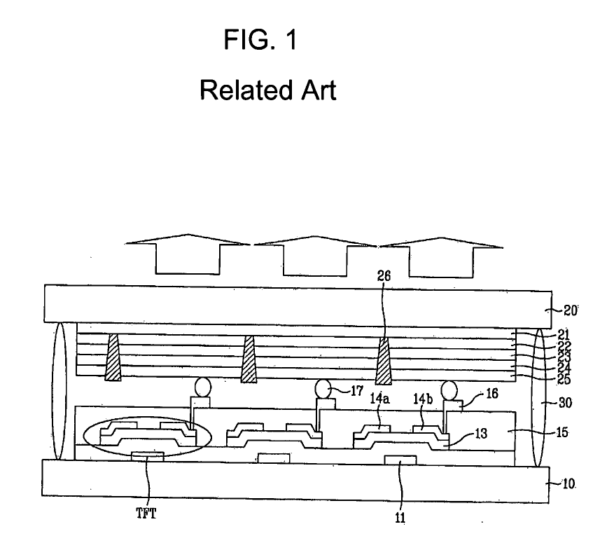

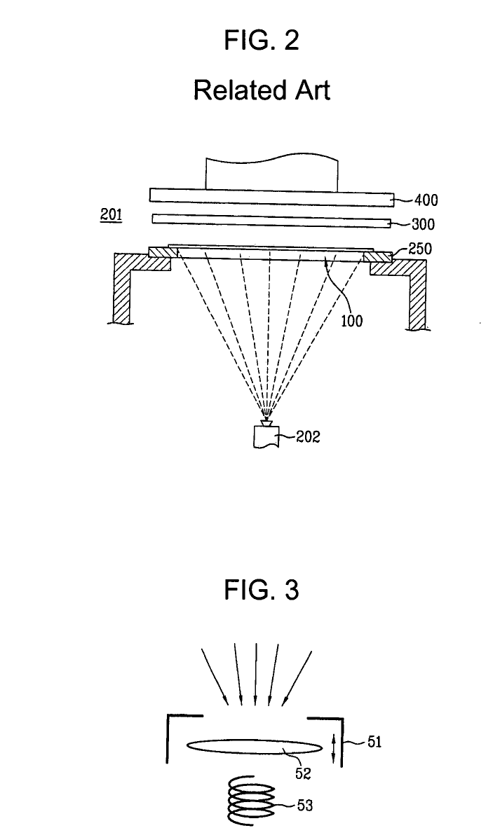

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a method of recycling a crystal sensor used for an evaporation apparatus according to the present invention will be described with reference to the accompanying drawings.

FIG. 3 is a schematic view of illustrating a sensing unit of an evaporation apparatus according to the present invention.

As shown in FIG. 3, the sensing unit of the evaporation apparatus according to the present invention is comprised of a case 51 which has an open portion therein; a vibrator 53 which makes a vibration and is positioned inside the case 51; and a crystal sensor 52 which monitors an evaporation level of material supplied through the open portion of the case 51 based on the vibration made from the vibrator 53.

The sensing unit is used for the evaporation apparatus to evaporate and deposit a predetermined material on a substrate, wherein the predetermined material may be an organic material, a metal material or an inorganic material.

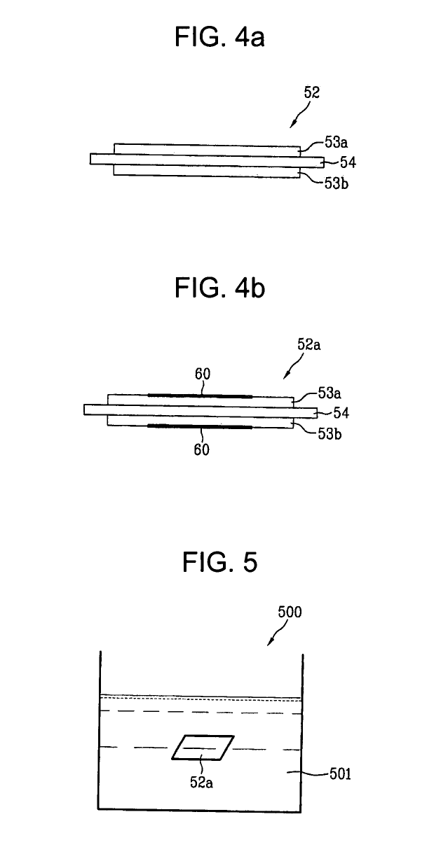

FIG. 4A is a cross section view of illustrating the initial state in the evaporation process of the crystal sensor, and FIG. 4B is a cross section view of illustrating the state after completing the curing process.

As shown in FIG. 4A, on the initial state of the crystal sensor 52, there are a parent metal 54 of Alumina or Teflon; and first and second contact electrodes 53a and 53b formed on both surfaces of the parent metal 54. At this time, the first and second contact electrodes 53a and 53b may be formed of aurum (Au), argentums (Ag), aluminum alloy (Al alloy), or stress relieving alloy. The crystal sensor 52 is initially vibrated at 5 or 6 MHz.

Referring to FIG. 4B, as increasing the time period of monitoring the thickness of thin film formed on a substrate by the evaporation device using the crystal sensor 52, the thin film 60 of organic or inorganic material (inclusive of the metal) adhered to the first and second contact electrodes 53a and 53b increases in thickness.

As the evaporated thin film 60 increases in thickness, the sensitivity of the first and second contact electrodes 53a and 53b becomes low. That is, the crystal sensor 52 has a high error possibility in monitoring the thickness of the thin film, whereby the accuracy in monitoring the thickness of thin film is lowered.

To overcome this problem, there is a requirement for the periodic replacement of the crystal sensor. However, since the crystal sensor is expensive, the present invention uses the method of recycling the crystal sensor 52.

Hereinafter, a method of recycling the crystal sensor of the evaporation apparatus according to the present invention will be explained as follows.

FIG. 5 illustrates a cleaning method of the crystal sensor according to the present invention.

The recycling method of the crystal sensor of the evaporation apparatus (FIG. 3) is carried out in the following steps. First, the crystal sensor 52a of the evaporation apparatus, which performs the process to monitor the thickness of material evaporated and deposited on the substrate (not shown) for the preset period of time, is collected. Then, as shown in FIG. 5, the crystal sensor 52a is dipped into a wet etchant 501, to thereby clean the crystal sensor 52a. At this time, ultrasonic waves are applied to the cleaning process. If the evaporated organic material is deposited on the substrate, the wet etchant 501 is formed of at least any one of an organic solvent, for example, acetone, IPA (alcohol-based (OH-based) material including Isopropyl Alcohol), MC (Methylene Chloride), THF (Tetrahydrofuran) and dichloride propane. In case of that the evaporated inorganic material is deposited on the substrate, the wet etchant 501 is formed of an inorganic solvent, for example, acid-mixed solvent or alkali-mixed solvent.

The above-mentioned cleaning process is performed by dipping the crystal sensor 52a into the wet etchant 501. Thus, the evaporated thin film 60 is removed from the surface of the first and second contact electrodes 53a and 53b of the crystal sensor 52a. Then, deionized water (DI) is applied to the surface of the first and second contact electrodes 53a and 53b, whereby the evaporated thin film 60 is completely removed from the surface of the first and second contact electrodes 53a and 53b of the crystal sensor 52a.

After that, the cleaned crystal sensor is dried. The drying process is performed at a temperature of 80° C. to 500° C. In this case, the drying process may be performed at a room temperature. However, if the drying process uses a heater, the time period of drying the cleaned crystal sensor becomes shorter, thereby decreasing the time period of recycling the crystal sensor.

For the cleaning process on the recycling method, one or more crystal sensors may be dipped into the wet etchant. Furthermore, the time period of removing the evaporated thin film may be shortened by controlling the strength of wet etchant.

At this time, the crystal sensor is periodically cleaned and dried. That is, after performing the crystal sensor for the preset period of time, the crystal sensor is cleaned and dried. At this time, the crystal sensor corresponds to the crystal sensor (FIG. 3) of the evaporation device, which is used to form the organic light-emitting layer or the electrode layer when forming the OLED device.

As mentioned above, the method of recycling the crystal sensor according to the present invention has the following advantages.

For the recycling method of the crystal sensor according to the present invention, the evaporated thin film is removed from the surface of the contact electrode by dipping the crystal sensor into the wet etchant, whereby the crystal sensor is reused and the process cost is decreased.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of recycling a crystal sensor of an evaporation device comprising:
collecting the crystal sensor after performing a monitoring step for a material evaporated and deposited on a substrate for a preset period of time;
cleaning the crystal sensor by dipping the crystal sensor into a wet etchant; and
drying the cleaned crystal sensor.

2. The method of claim 1, wherein cleaning the crystal sensor is performed by applying ultrasonic waves.

3. The method of claim 1, wherein drying the cleaned crystal sensor is performed at a temperature of 80° C. to 500° C.

4. The method of claim 1, wherein the material evaporated and deposited on the substrate is an organic material.

5. The method of claim 4, wherein cleaning the crystal sensor uses an organic solvent.

6. The method of claim 5, wherein the organic solvent is formed of at least one of acetone, IPA (alcohol-based (OH-based) material including Isopropyl Alcohol), MC (Methylene Chloride), THF (Tetrahydrofuran) and dichloride propane.

7. The method of claim 1, wherein the material evaporated and deposited on the substrate is an inorganic material.

8. The method of claim 7, wherein cleaning the crystal sensor uses an inorganic solvent.

9. The method of claim 8, wherein the inorganic solvent is formed of acid-mixed solvent.

10. The method of claim 8, wherein the inorganic solvent is formed of alkali-mixed solvent.

11. The method of claim 1, wherein the crystal sensor is periodically cleaned and dried.
